(19) United States
(12) Patent Application Publication
(10) Pub. No.: US 2006/0247952 A1
(43) Pub. Date: Nov. 2, 2006

(54) Method and apparatus of transmitting patient medical data between a client computer and a server using electronic mail

(75) Inventor: John R. Muraca, Utica, NY (US)

Correspondence Address: STAAS & HALSEY LLP, SUITE 700, 1201 NEW YORK AVENUE, N.W., WASHINGTON, DC, 20005, US

(73) Assignee: VISUAL TELECOMMUNICATIONS NETWORK, INC., McLean, VA (US)

(21) Appl. No.: 11/116,389

(22) Filed: Apr. 28, 2005

(51) Int. Cl. G06F 19/00; G06Q 99/00; G06F 15/16

(52) U.S. Cl. 705/3; 705/51; 709/206

(57) ABSTRACT

A method, apparatus, and computer readable medium transmits data between a client computer and a server in communication with each other, including compressing, privatizing and encrypting, by the client computer, the data including patient medical data of a patient into a file, and automatically generating and transmitting to the server by the client computer an electronic mail message having the file as a secure patient medical attachment to the electronic mail message, and automatically interrogating by the server a mailbox corresponding to the patient and residing on the server for an electronic mail message, and obtaining the patient medical data by the server by authenticating a user to the server and decompressing, deprivatizing and decrypting, the secure patient medical attachment upon receiving the electronic mail message with the secure patient medical attachment.

### BACKGROUND OF THE INVENTION

1. Field of the Invention

The present invention is directed to transmitting data between a client computer and a server, and, more particularly, to transmitting patient medical data between a client computer and a server.

2. Description of the Related Art

Computer systems which store and transmit data associated with patient medical information are known in the art. Such conventional computer systems use a variety of techniques to transfer the patient medical data from one computer to another computer. These techniques include directly connecting the computers to each other and physically copying a file containing the patient medical data from one of the computers to another of the computers, for example, implemented by a listener using tunneling, transferring a file among the computers coupled to each other via a local area network (LAN), and coupling the computers to each other through a WorldWide Web (Web) interface, with the data transfer controlled by a Web server.

What is needed is a system and method to transfer patient medical data between a client computer and a server with greater ease and flexibility.

### SUMMARY OF THE INVENTION

It is an aspect of the present invention to provide a system and method to transfer patient medical data from a client computer to a server with greater ease and flexibility.

The above aspect can be attained by a system, method, and computer readable medium that transmits data between a client computer and a server in communication with each other, including compressing, privatizing and encrypting, by the client computer, the data comprising patient medical data of a patient into a file, and automatically generating and transmitting to the server by the client computer an electronic mail message having the file as a secure patient medical attachment to the electronic mail message. The system, method, and computer readable medium also include automatically interrogating by the server a mailbox corresponding to the patient and residing on the server for an electronic mail message, and obtaining the patient medical data by the server by authenticating a user to the server and decompressing, deprivatizing, and decrypting the secure patient medical attachment upon receiving the electronic mail message with the secure patient medical attachment.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1A shows an embodiment of a computer system of the present invention.

FIG. 1B shows compressing and encrypting a patient medical file in the present invention.

FIG. 2 shows a method of receiving patient monitoring and information distribution of the present invention.

FIG. 3 shows a method of updating patient monitoring and information distribution of the present invention.

FIG. 4 shows a configuration of the mailbox corresponding to the client computer and residing on the server.

FIG. 5 shows a configuration of the mailbox corresponding to the health care provider apparatus and residing on the server.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout.

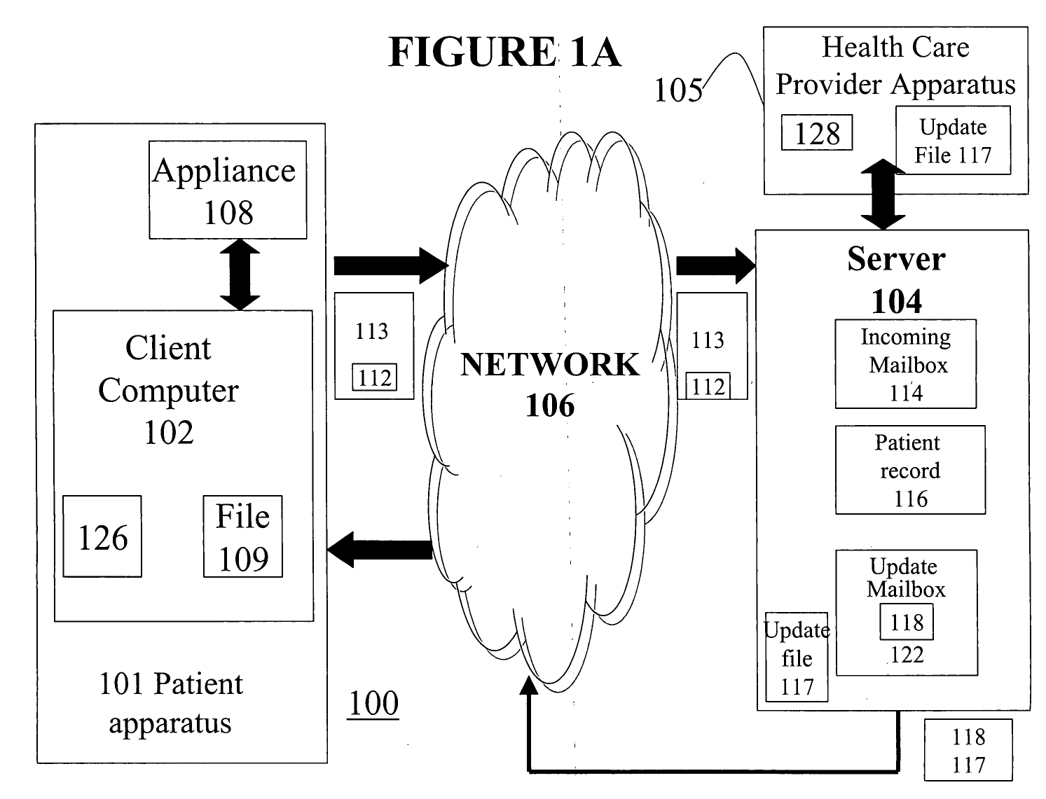

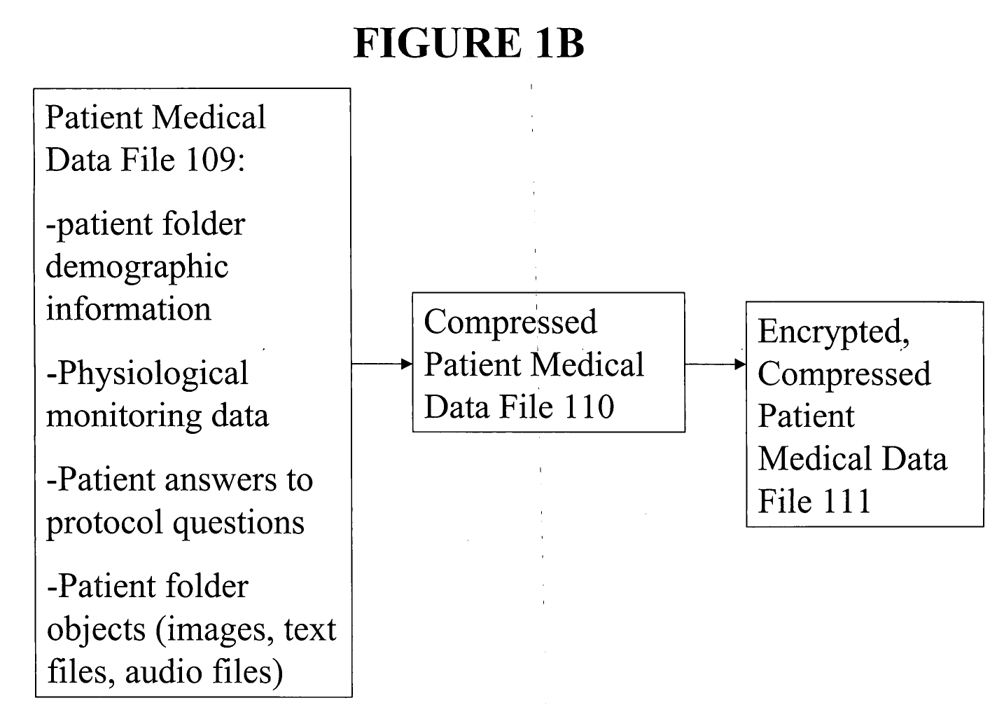

FIG. 1A shows a computer system 100 of the present invention including a patient apparatus 101 and a server 104 in communication with each other by a computer network 106, such as the Internet.

The computer system 100 of the present invention monitors the patient and distributes information about the patient from the patient apparatus 101 to the server 104 through the network 106 and to the health care provider apparatus 105.

In an embodiment of the present invention, the server 104 is a computer workstation operating in a call center (CallCenter) and is configured to execute functions of a mail server normalize the patient record 116 stored on the server 104. The server 104 is in communication with a health care provider apparatus 105, such as a computer workstation.

In an embodiment of the present invention, the patient apparatus 101 is operated by a user, such as a patient, and is remotely configurable. The patient apparatus 101, which functions as a home health monitoring system, includes a client computer 102 which is either coupled to a patient appliance 108 which interfaces to the patient, to obtain patient physiological information and/or responses to questions of well-being posed to the patient, or is itself configured to obtain patient medical data.

The patient medical data includes patient folder demographic information, physiological monitoring data, patent answers to protocol questions, and patient folder objects (images, text files, audio files, etc.), and is stored in a patient medical data file 109 on the client computer 102.

In an example of an embodiment of the present invention, the patient appliance 108 is a medical monitor such as a blood glucose monitor collecting, for example, blood glucose information about the patient as the patient physiological information. The patient appliance 108 then transfers the blood glucose information to the client-computer 102.

Compressing, Privatizing and Encrypting the Patient Medical Data

As shown in FIG. 1B, the client computer 102 of the present invention then compresses the patient medical data file 109 with password security into a compressed patient medical data file 110 to reduce the size of the patient medical data file 109, then encrypts the compressed patient medical data file 110 into an encrypted, compressed patient medical data file 111 to secure the patient medical data. Applying password security as the patient medical data file is being compressed is referred to as privatizing the patient medical data included in the compressed patient medical data file 110.

In an embodiment of the present invention, third party commercially-available compression/decompression software known in the art is used to compress and password-protect the patient medical data file 109.

In an embodiment of the present invention, third party commercially-available 128-bit DES encryption/decryption procedures known in the art are used to encrypt the compressed patient medical data file 110.

The present invention then attaches the compressed, encrypted patient medical data file 111 as a secure patient medical attachment 112 to an electronic mail message 113, as explained herein below.

The present invention uses the above-mentioned 128-bit DES encryption/decryption procedures to protect all electronic mail attachments (including the above-mentioned secure patient medical attachment 112 and the update data 117 discussed herein below) to e-mail messages and all IP message traffic traveling between the patient apparatus 101, the server 104, and the health care provider apparatus 105 before being transmitted computer to computer.

Prior to decryption commencement, any user of the server 104 or the client computer 102 must be authenticated, to prevent unauthorized access to any data, including the patient medical data 110 and update data 117, being transmitted by the computer system 100.

Transmitting Patient Medical Data from the Patient Apparatus 101 to the Server 104

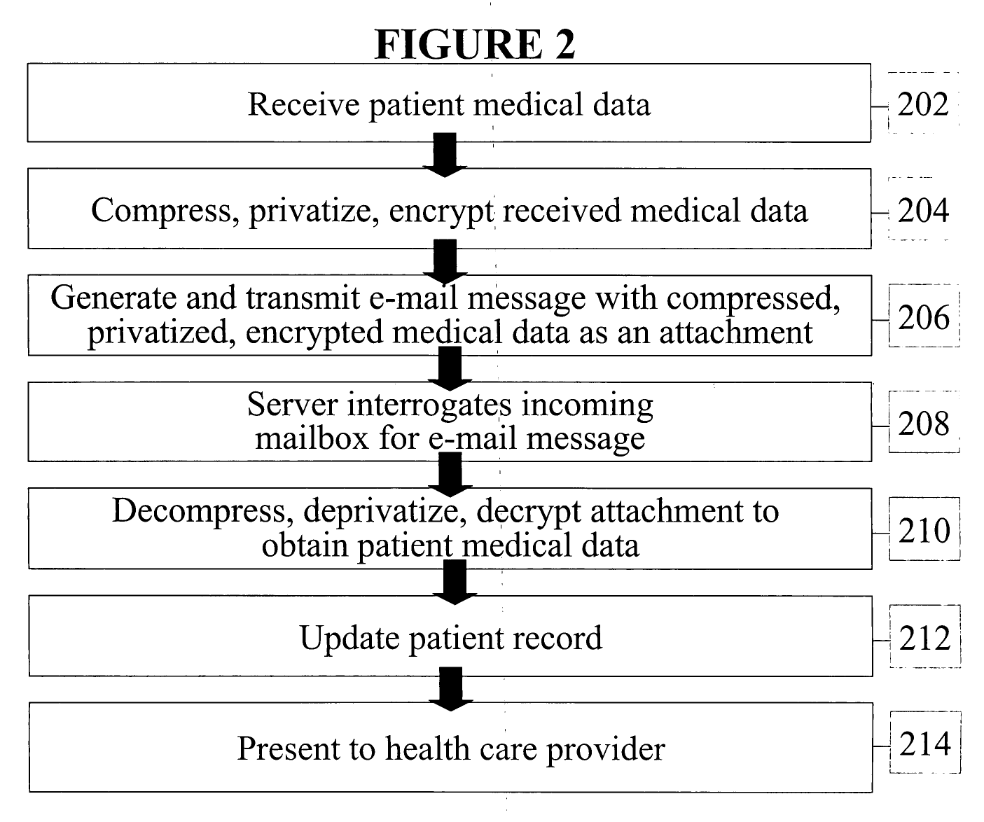

A method 200 of the computer system 100 of the present invention of transmitting patient medical data 109 from the patient apparatus 101 to the server 104 and, subsequently, to the health care provider apparatus-105 is now discussed, with reference to FIGS. 1A and 2.

The method 200 of the present invention uses the SMTP protocol to deliver mail (Pop3 mail) from the patient apparatus 101. All messages are encrypted with the above-mentioned 128-bit DES encryption/decryption procedures to protect all IP message traffic, computer to computer.

Once the client computer 102 receives the patient medical data from the patient, the client computer 102 compresses, encrypts, and privatizes 204 the patient medical data into a file 111.

The patient medical data 109 is compressed, privatized, and encrypted by the client computer 102 prior to attaching the patient medical data 111 to the e-mail message 113 to transmit to the server 104 as secure patient medical attachment 112.

The client computer 102 then automatically generates and transmits 206 to the server 104 via the network 106 an electronic mail message (or e-mail message) 113 having the secure patient medical attachment 112. In one embodiment of the present invention, the SMTP protocol is used to transmit the e-mail message 113 to the server 104.

The e-mail message is automatically generated by the client computer 102 upon the user or patient either completing responses to a questionnaire displayed on the client computer 102 or the user or patient clicking a “Send” button displayed on the client computer 102.

The server 104 automatically interrogates 208 an incoming mailbox 114 corresponding to the patient and residing on the server 104 for an electronic mail message.

Once the electronic mail message 113 having the attachment 112 is received by the server 104, the server 104 obtains 210 the patient medical data 109 by authenticating a user to the server 104 and removing the secure patient medical attachment 112 from the electronic mail message 113, and decompresses, deprivatizes and decrypts the secure patient medical attachment 112 into the patient medical data 109, using the above-mentioned compression/decompression software and 128-bit DES encryption/decryption procedures.

The server 104 then updates 212 a patient record 116 in an ODBC-compliant data base corresponding to the patient and based upon the patient medical data 109 obtained by the server 104 from the secure patient medical attachment 112.

The server 104 then presents 214 the patient medical data 109 to a health care provider by the health care-provider accessing the patient record 116 stored on the server 104 using the health care provider apparatus 105.

When the patient medical data 109 arrives at the health care provider apparatus 105, the patient medical data 109 is processed for further management of the patient health condition by a health care provider.

Transmitting Update Data to the Patient Apparatus 101

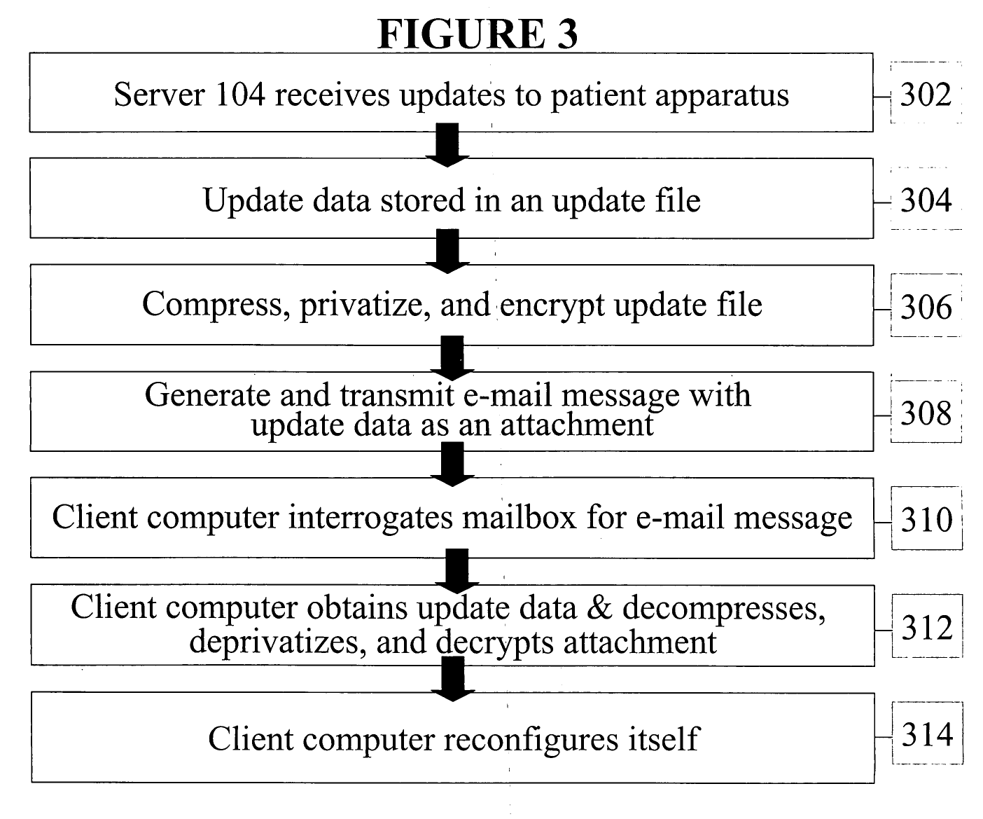

A method 300 of the computer system 100 of the present invention of transmitting update data from the server 104 to the patient apparatus 101 is now discussed, with reference to FIGS. 1A and 3. The update method 300 of the present invention uses the SMTP protocol and automatically delivers updates to the patient apparatus 101 on the subsequent delivery of e-mail from the patient apparatus 101. All messages are encrypted with a 128-bit DES encryption/decryption procedures to protect all IP message traffic, computer to computer.

The health care provider accesses the updated patient record 116 stored on the server 104 by the health care provider apparatus 105.

Upon review by the health care provider of the patient record 116 updated based upon the newly-received patient medical data 109, the health care provider may decide to update the patient apparatus 101. For example, the health care provider may decide to update the questions of well-being posed to the patient by the patient apparatus 101.

Similar to the process shown in FIG. 1B to generate a secure patient medical attachment 112, a secure update attachment 117 is generated by the health care provider apparatus 105 (such as a computer) by compressing, privatizing (password-protecting), and encrypting an update file 117 into a secure update attachment 117 transmitted to the server 104 or to the patient apparatus 101.

The health care apparatus 105 then compresses, privatizes and encrypts 304 the secure update attachment 117 using the above-mentioned 128-bit encryption/decryption procedures, and automatically generates 308 an e-mail message 118 having the compressed, encrypted, and privatized update data as the secure update attachment 117 to the e-mail message 118.

The health care apparatus 105 transmits 302 the secure update attachment 117 to be applied to the patient apparatus 101 to the server 104, which stores 303 the update data in secure update attachment 117. The update data 117 may be, for example, revised questions for the patient.

Updates are then deposited 308 into a designated update mailbox 122 residing on the server 104 with each containing a unique encrypted identifier that is used to ensure delivery to the proper patient apparatus 101.

The client computer 102 then automatically interrogates 310 the update mailbox 122 for an electronic mail message 118 designated for the client computer 102 and residing on the server 104, and obtains 312 the update data 117 by decompressing, decrypting, and deprivatizing (entering the password) the secure update attachment 117.

The client computer 102 then updates (or reconfigures) itself 314 based upon the update data 117 obtained by the client computer 102 from the attachment to the electronic mail message 118.

In an embodiment of the present invention, the update method 300 of the present invention may also be used to transmit updates to the client computer 102 independently of updates requested by the health care provider.

Client Computer 102 and Health Care Apparatus 105 Mailbox Setup

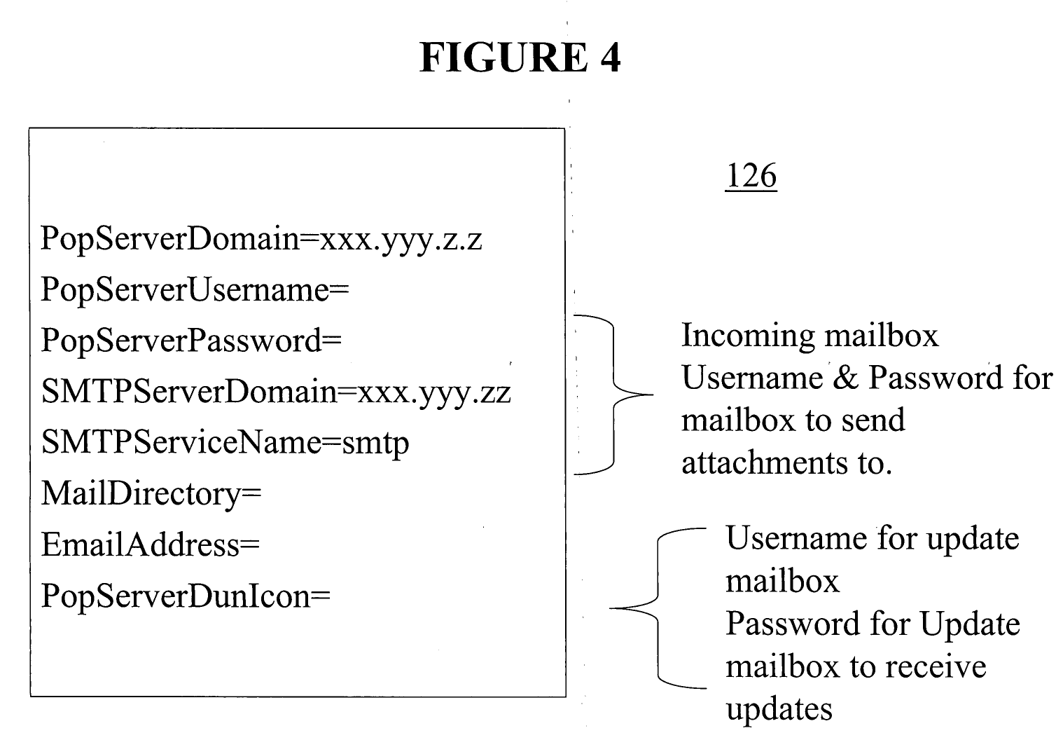

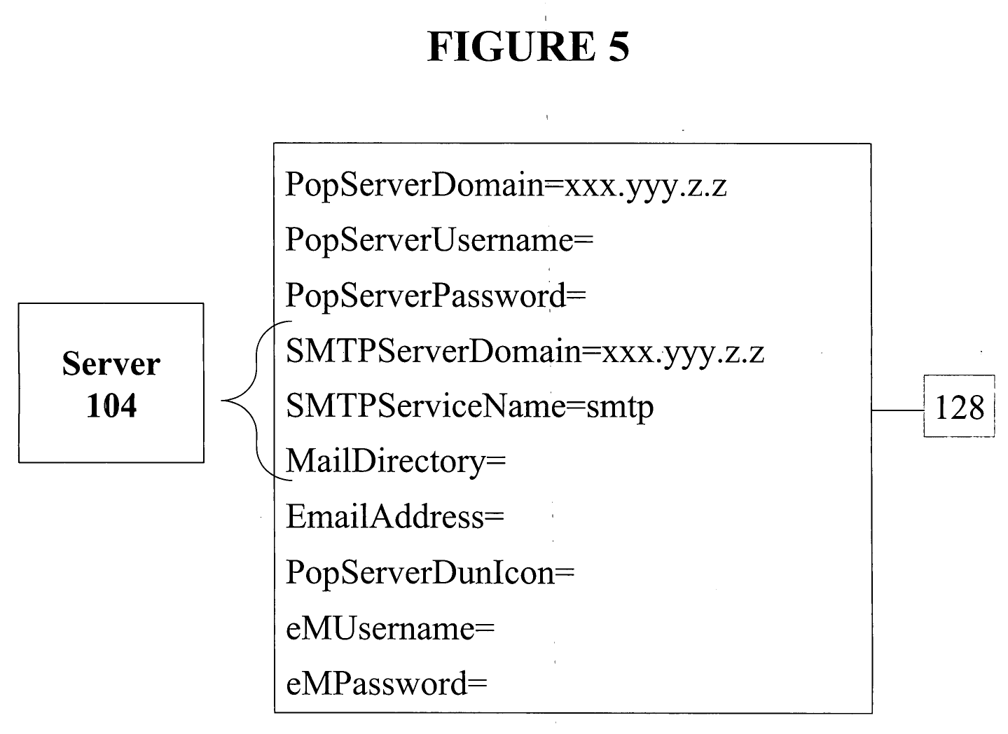

FIG. 4 shows a configuration 126 of the mailbox of the client computer 102, and FIG. 5 shows a configuration 128 of the health care provider apparatus 105.

In the configurations 126, 128 of FIG. 4 and FIG. 5, the address of the server is xxx.yyy.z.z. In both the mailbox 126 and the mailbox 128, the PopServerDomain and the SMTPServerDomain are both set to the address of the server 104

Referring now to FIG. 4, the configuration 126 of the mailbox points to the incoming mailbox 114 and the update mailbox 122. For the incoming mailbox 114, the username and password for the mailbox to send the e-mail message 113 with attachment 112 are identified, and the username and password for the update mailbox 122 to receive updates 117 are identified. If an e-mail message 118 with a secure update attachment 117 exists, the e-mail message 118 with the update attachment 117 is retrieved by the client computer 102 and processed by the client computer 102 to reconfigure the client computer 102 as discussed herein above. The client computer 102 processes the e-mail message with secure update attachment 117 by identifying a match on the primary index, in subject.

Referring now to FIG. 5, the configuration 128 of the mailbox points to the update mailbox 122. In the configuration 128, the PopServerPassword, the SMTPServerDomain (which is set to the address of the server 104), and the SMTPServiceName (which is set to smtp) refer to the server 104.

Once the health care provider apparatus 105 updates the patient record 116, the user of the health care provider apparatus 105 clicks a “Send Update” button on a screen displayed on the health care provider apparatus 105. The e-mail message 118 with the update attachment 117 is e-mailed to the update mailbox 122 (with the subject=encoded primary index).

The computer system 100 of the present invention monitors and distributes patient information by automatically receiving, managing, filing, and distributing patient information. The computer system 100 of the present invention provides a secure, enterprise-wide communication infrastructure for all information managed by an institution and is scalable to support a single user up to tens of thousands of users. The computer system 100 of the present invention serves as an enterprise messaging gateway and provides secured, auditable receipt management and dissemination of transactions required to comply with HIPPA legislation.

The computer system 100 and methods 200 and 300 of the present invention enable a health care provider to monitor and manage a health condition of a patient. The computer system 100 of the present invention includes a health care provider apparatus 105 operated by a health care provider and a remotely configurable patient apparatus 101 operated by a patient. The health care provider configures the patent apparatus 101 by using the health care provider apparatus 105 and then sends the new configuration 117 to a remote patient apparatus 101 through the computer system 100.

The patient medical data 110 and, thus, secure patient medical attachment 112, includes the patient protocol that provides information to the patient and that interactively monitors the patient health condition by asking the patient questions and by receiving answers to those questions. The answers to these health related questions are then forwarded as part of the patient medical data 110 from the remote patient apparatus 101 to the health care provider apparatus 105 through the computer system 100. The patient medical data 110 may also include information supplied by a physiological monitoring device 108 such as a blood glucose monitor that is connected to the remotely programmable patient apparatus 101. When the patient data arrives at the health care provider apparatus 1 05, the patient data is processed for further management of the patient's health condition by the health care provider, such as forwarding another configuration to the remotely configurable patient apparatus 101.

The system also includes permanent or removable storage, such as magnetic and optical discs, RAM, ROM, etc. on which the process and data structures of the present invention can be stored and distributed. The processes can also be distributed via, for example, downloading over a network such as the Internet.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method of transmitting data between a client computer and a server in communication with each other, comprising:
compressing, privatizing and encrypting, by the client computer, the data comprising patient medical data of a patient into a file, and automatically generating and transmitting to the server by the client computer an electronic mail message having the file as a secure patient medical attachment to the electronic mail message; and
automatically interrogating by the server a mailbox corresponding to the patient and residing on the server for an electronic mail message, and obtaining the patient medical data by the server by authenticating a user to the server and decompressing, deprivatizing and decrypting the secure patient medical attachment upon receiving the electronic mail message with the secure patient medical attachment.

2. The method as in claim 1, wherein the patient medical data comprises responses by the patient to questions and/or physiological data of the patient.

3. The method as in claim 2, further comprising updating, by the server, a patient record corresponding to the patient and based upon the patient medical data obtained by the server from the secure patient medical attachment.

4. The method as in claim 3, further comprising presenting by the server the patient medical data to a health care provider.

5. The method as in claim 4, further comprising receiving from the health care provider update data for the client computer.

6. The method as in claim 5, further comprising:
compressing, privatizing and encrypting, by the health care provider apparatus, the update data into an update file, and automatically generating and transmitting to the client computer by the server an electronic mail message having the update file as a secure update attachment to the electronic mail message; and
automatically interrogating by the client computer a mailbox residing on the server computer for an electronic mail message designated for the client computer, and obtaining the update data by the client computer by decompressing, deprivatizing and decrypting, the secure update attachment upon receiving the electronic mail message with the secure update attachment.

7. The method as in claim 6, further comprising updating the client computer based upon the update data obtained by the client computer from the secure update attachment to the electronic mail message.

8. The method as in claim 1, further comprising:
compressing, privatizing and encrypting, by the health care provider apparatus, update data into an update file, and automatically generating and transmitting to the client computer by the server an electronic mail message having the update file as a secure update attachment to the electronic mail message; and
automatically interrogating by-the client-computer a mailbox residing on the server for an electronic mail message designated for the client computer, and obtaining the update data by the client computer by decompressing, deprivatizing and decrypting, the secure update attachment upon receiving the electronic mail message with the secure update attachment.

9. The method as in claim 8, further comprising updating the client computer based upon the update data obtained by the client computer from the secure update attachment to the electronic mail message.

10. The method as in claim 8, wherein the transmitting to the client computer by the server an electronic mail message having the update file as a secure update attachment to the electronic message is in response to receiving by the server the electronic mail message having the patient medical data transmitted from the client computer.

11. At least one computer readable medium storing at least one program which, when executed by a computer system including a client computer in communication with a server, executing functions of transferring data between the client computer and the server, comprising:
compressing, privatizing and encrypting by the client computer, the data comprising patient medical data of a patient into a file, and automatically generating and transmitting to the server by the client computer an electronic mail message having the file as a secure patient medical attachment to the electronic mail message; and
automatically interrogating by the server a mailbox corresponding to the patient and residing on the server for an electronic mail message, and obtaining the patient medical data by the server by authenticating a user to the server and decompressing, deprivatizing and decrypting the secure patient medical attachment upon receiving the electronic mail message with the secure patient medical attachment.

12. The at least one computer readable medium as in claim 11, wherein the patient medical data comprises responses by the patient to questions and/or physiological data of the patient.

13. The at least one computer readable medium as in claim 12, further comprising updating, by the server, a patient record corresponding to the patient and based upon the patient medical data obtained by the server from the secure patient medical attachment.

14. The at least one computer readable medium as in claim 13, further comprising presenting by the server the patient medical data to a health care provider.

15. The at least one computer readable medium as in claim 14, further comprising receiving from the health care provider update data for the client computer.

16. The at least one computer readable medium as in claim 15, further comprising:
compressing, privatizing and encrypting, by the health care provider apparatus, the update data into an update file, and automatically generating and transmitting to the client computer by the server an electronic mail message having the update file as a secure update attachment to the electronic mail message; and
automatically interrogating by the client computer a mailbox residing on the server computer for an electronic mail message designated for the client computer, and obtaining the update data by the client computer by decompressing, deprivatizing and decrypting the secure patient medical attachment upon receiving the electronic mail message with the secure patient medical attachment.

17. The at least one computer readable medium as in claim 16, further comprising updating the client computer based upon the update data obtained by the client computer from the secure update attachment to the electronic mail message.

18. The at least one computer readable medium as in claim 11, further comprising:
compressing, privatizing and encrypting, by the health care provider apparatus, update data into an update file, and automatically generating and transmitting to the client computer by the server an electronic mail message having the update file as a secure update attachment to the electronic mail message; and
automatically interrogating by the client computer a mailbox residing on the server for an electronic mail message designated for the client computer, and obtaining the update data by the client computer by decompressing, deprivatizing and decrypting, the secure update attachment upon receiving the-electronic mail message with the secure update attachment.

19. The at least one computer readable medium as in claim 18, further comprising updating the client computer based upon the update data obtained by the client computer from the secure update attachment to the electronic mail message.

20. The at least one computer readable medium as in claim 18, wherein the transmitting to the client computer by the server an electronic mail message having the update file as a secure update attachment to the electronic message is in response to receiving by the server the electronic mail message having the patient medical data transmitted from the client computer.

21. A computer system transferring data between a client computer and a server in communication with each other, comprising:
a client computer compressing,privatizing and encrypting the data comprising patient medical data of a patient into a file, and automatically generating and transmitting an electronic mail message having the file as a secure patient medical attachment to the electronic mail message; and
a server, in communication with the client computer, automatically interrogating a mailbox corresponding to the patient and residing on the server for an electronic mail message, and obtaining the patient medical data by the-server by decompressing, deprivatizing and decrypting, the secure patient medical attachment upon receiving the electronic mail message with the secure patient medical attachment.

22. The computer system as in claim 21, wherein the server updating a patient record corresponding to the patient and based upon the patient medical data obtained by the server from the secure patient medical attachment.

23. The computer system as in claim 22, wherein the server presenting the patient medical data to a health care provider.

24. The computer system as in claim 23, wherein the server receiving from the health care provider update data for the client computer.

25. The computer system as in claim 24, wherein:
the health care provider apparatus further comprising compressing, privatizing and encrypting the update data into an update file, and automatically generating and transmitting to the client computer by the server an electronic mail message having the update file as a secure update attachment to the electronic mail message; and
the client computer further comprising automatically interrogating a mailbox residing on the server for an electronic mail message designated for the client computer, and obtaining the update data by the client computer by decompressing, decrypting, and deprivatizing the secure update attachment upon receiving the electronic mail message with the secure update attachment.

26. The computer system as in claim 25, further comprising wherein the client computer updating itself based upon the update data obtained by the client computer from the secure update attachment to the electronic mail message.

27. The computer system as in claim 22, wherein:
the health care provider apparatus further comprising compressing, privatizing and encrypting the update data into an update file, and automatically generating and transmitting to the client computer by the server an electronic mail message having the update file as a secure update attachment to the electronic mail message; and
the client computer further comprising automatically interrogating a mailbox residing on the server for an electronic mail message designated for the client computer, and obtaining the update data by the client computer by decompressing, deprivatizing and decrypting the secure update attachment upon receiving the electronic mail message with the secure update attachment.

28. The computer system as in claim 27, wherein the client computer updating itself based upon the update data obtained by the client computer from the secure update attachment to the electronic mail message.

29. The computer system as in claim 27, wherein the server transmitting to the client computer an electronic mail message having the update file as a secure update attachment to the electronic message is in response to receiving by the server the electronic mail message having the patient medical data transmitted from the client computer.

30. The computer system as in claim 21, further comprising:
a computer network coupled between the client computer and the server and transmitting the electronic mail messages between the client computer and the server.
